(19) United States
(12) Patent Application Publication
(10) Pub. No.: US 2010/0164309 A1
(43) Pub. Date: Jul. 1, 2010

(54) SUPERCONDUCTING MOTOR APPARATUS

(75) Inventors: Yoshimasa OHASHI, Kariya-shi (JP); Sho Mitsuhashi, Nagoya-shi (JP); Nobuo Okumura, Toyota-shi (JP); Hidetoshi Kusumi, Nagoya-shi (JP)

Correspondence Address: BUCHANAN, INGERSOLL & ROONEY PC, POST OFFICE BOX 1404, ALEXANDRIA, VA, 22313-1404, US

(73) Assignees: AISIN SEIKI KABUSHIKI KAISHA, Kariya-shi (JP); TOYOTA JIDOSHA KABUSHIKI KAISHA, Toyota-shi (JP)

(21) Appl. No.: 12/640,520

(22) Filed: Dec. 17, 2009

(30) Foreign Application Priority Data
Dec. 26, 2008 (JP) 2008-331754

(51) Int. Cl. H02K 5/24; H02K 9/00

(52) U.S. Cl. 310/51; 310/52

(57) ABSTRACT

A superconducting motor apparatus includes a superconducting motor including a superconducting coil and a mover movable on a basis of a movable magnetic field generated by the superconducting coil when an electric power is supplied thereto, a container defining an outer vacuum heat insulation chamber that covers an outer side of the superconducting motor, an extremely low temperature generating portion cooling the superconducting coil of the superconducting motor to a temperature equal to or smaller than a critical temperature of the superconducting coil, and a vibration damping element restraining one of or both of a vibration of the superconducting motor and an external vibration from being propagated to the extremely low temperature generating portion.

### CROSS REFERENCE TO RELATED APPLICATIONS

This application is based on and claims priority under 35 U.S.C. §119 to Japanese Patent Application 2008-331754, filed on Dec. 26, 2008, the entire content of which is incorporated herein by reference.

### TECHNICAL FIELD

This disclosure relates to a superconducting motor apparatus.

### BACKGROUND DISCUSSION

A known superconducting motor apparatus includes a superconducting motor having a superconducting coil and a rotor that rotates on the basis of a rotational magnetic field generated by the superconducting coil when an electric power is supplied thereto, a container defining an outer vacuum heat insulation chamber covering an outer peripheral side (outer side) of the superconducting motor, and a refrigerator cooling the superconducting coil of the superconducting motor to a temperature equal to or smaller than a critical temperature of the superconducting coil. Such superconducting motor apparatus is disclosed in JP2007-89345A.

According to the superconducting motor apparatus disclosed in JP2007-89345A, a vibration of the superconducting motor and/or an external vibration may be propagated to the refrigerator. In that case, durability and lifetime of the refrigerator may be deteriorated. Further, a refrigerating performance of the refrigerator may decrease.

A need thus exists for a superconducting motor apparatus which is not susceptible to the drawback mentioned above.

### SUMMARY

According to an aspect of this disclosure, a superconducting motor apparatus includes a superconducting motor including a superconducting coil and a mover movable on a basis of a movable magnetic field generated by the superconducting coil when an electric power is supplied thereto, a container defining an outer vacuum heat insulation chamber that covers an outer side of the superconducting motor, an extremely low temperature generating portion cooling the superconducting coil of the superconducting motor to a temperature equal to or smaller than a critical temperature of the superconducting coil, and a vibration damping element restraining one of or both of a vibration of the superconducting motor and an external vibration from being propagated to the extremely low temperature generating portion.

According to another aspect of this disclosure, a superconducting motor apparatus includes a superconducting motor including a superconducting coil and a mover movable on a basis of a movable magnetic field generated by the superconducting coil when an electric power is supplied thereto, a container defining an outer vacuum heat insulation chamber that covers an outer side of the superconducting motor, an extremely low temperature generating portion arranged to be adjoined to the superconducting motor and cooling the superconducting coil of the superconducting motor to a temperature equal to or smaller than a critical temperature of the superconducting coil, and a vibration damping element restraining a vibration from being propagated from the superconducting motor to the extremely low temperature generating portion.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a cross-sectional view of a superconducting motor apparatus according to a first embodiment disclosed here;

FIG. 2 is another cross-sectional view of the superconducting motor apparatus according to the first embodiment;

FIG. 3 is a cross-sectional view of a superconducting motor apparatus according to a second embodiment disclosed here;

FIG. 4 is a cross-sectional view of a superconducting motor apparatus according to a third embodiment disclosed here;

FIG. 5 is a cross-sectional view of a superconducting motor apparatus according to a fourth embodiment disclosed here;

FIG. 6 is a cross-sectional view of a superconducting motor apparatus according to a fifth embodiment disclosed here;

FIG. 7 is a cross-sectional view of a superconducting motor apparatus according to a sixth embodiment disclosed here; and

FIG. 8 is a cross-sectional view of a superconducting motor apparatus according to a seventh embodiment disclosed here.

### DETAILED DESCRIPTION

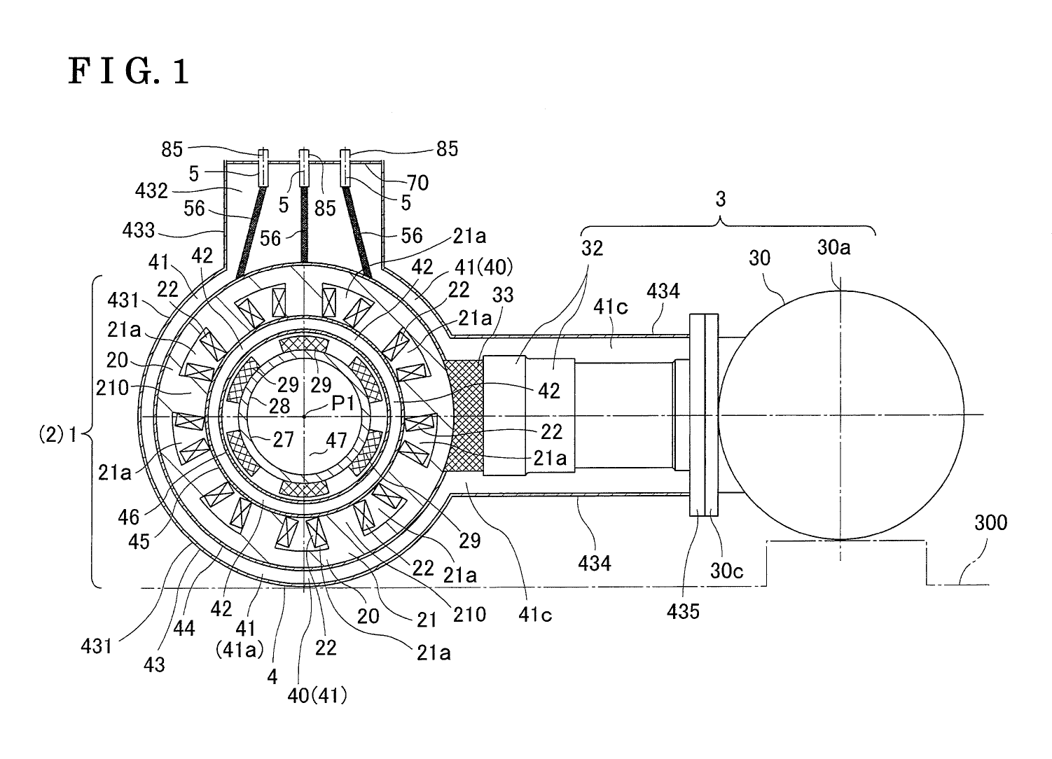

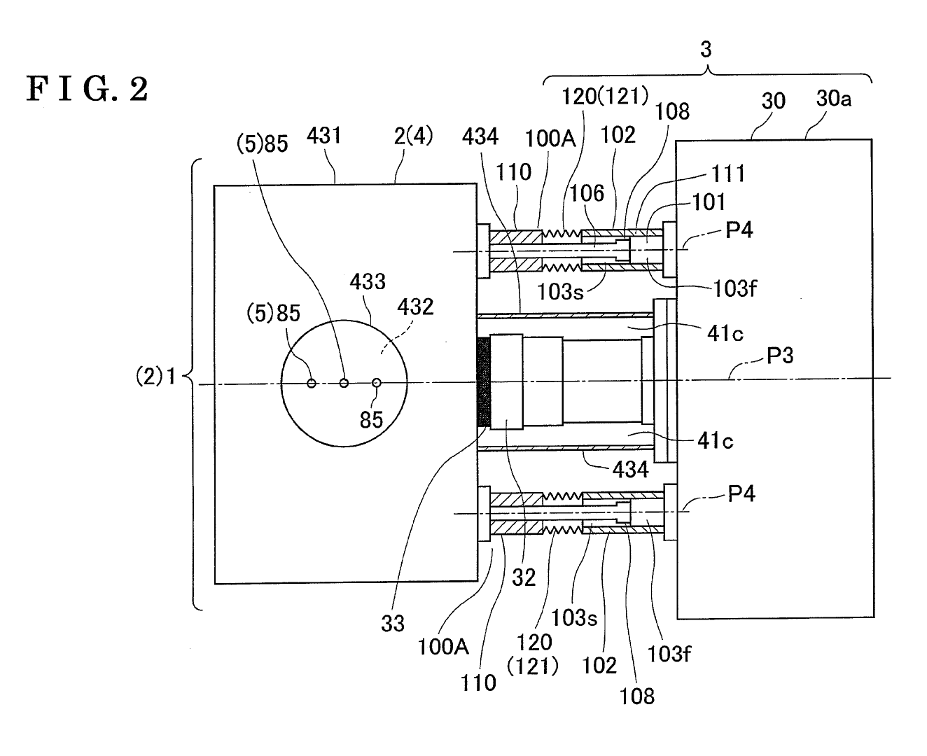

A first embodiment disclosed here will be explained with reference to FIGS. 1 and 2.

The embodiment applies to a superconducting motor device, which is an example of a magnetic field generator serving as a representative example of a superconducting apparatus. A superconducting motor device 1 may be used in a vehicle, in a stationary state, for an industrial purpose, and the like. The superconducting motor device 1, which is mounted on a frame 300 of a vehicle (i.e., a body of a vehicle), and the like, includes a superconducting motor 2 serving as a magnetic field generating portion, an extremely low temperature generating portion 3, a container 4, and electric current lead-in terminals 5 (hereinafter simply referred to as lead-in terminals 5).

The superconducting motor 2 serves as a motor to which a three-phase alternating current is supplied. The three phases are different from one another by 120 degrees each. The superconducting motor 2 includes a stator 20 having a cylindrical shape about an axial center P1 of the superconducting motor 2 and a rotor 27 serving as a mover rotatable relative to the stator 20. The rotor 27 includes a rotational shaft 28 rotatably supported about the axial center P1 of the superconducting motor 2 and multiple permanent magnet portions 29 arranged at equal intervals at an outer peripheral portion of the rotational shaft 28. The permanent magnet portions 29 are formed by known permanent magnets.

The stator 20 includes a stator core 21 and a superconducting coil 22. The stator core 21, which functions as a permeable core serving as a yoke, is formed into a cylindrical shape by a material having a high magnetic permeability. The superconducting coil 22 is wound on the stator core 21 and held thereat. The stator core 21 includes teeth portions 210 arranged in a circumferential direction while having equal distances so as to project in a radially inner direction of the stator core 21. The superconducting coil 22 is wound on the teeth portions 210. The superconducting coil 22 is divided into three portions so that the three-phase alternating current can be supplied. The superconducting coil 22 is formed by a known superconducting material. The superconducting coil 22 is arranged within throttle grooves 21a formed at an inner peripheral portion of the stator core 21. In a case where the three-phase alternating current is supplied to the superconducting coil 22, a rotational magnetic field is generated, rotating around the stator 20, i.e., the axial center P1 of the stator 20. The rotor 27 rotates about the axial center P1 by means of the rotational magnetic field, thereby obtaining a motor function.

The extremely low temperature generating portion 3 maintains the superconducting coil 22 at an extremely low temperature so as to retain a superconducting state of the superconducting coil 22. An extremely low temperature range obtained by the extremely low temperature generating portion 3 is selected depending on a material of the superconducting material that constitutes the superconducting coil 22. The temperature range may be equal to or smaller than a nitrogen liquefaction temperature. For example, the temperature range is equal to or smaller than 150K, specifically, equal to or smaller than 100K or 80K. At this time, however, the temperature range is not limited to such values and is dependent on the superconducting material forming the superconducting coil 22. The extremely low temperature generating portion 3 includes a refrigerator 30 having a cold head 32 serving as an extremely low temperature extraction portion where the extremely low temperature is generated. Then, a conductive portion 33 having a temperature conductive material as a base material is provided for connecting the cold head 32 of the refrigerator 30 to the stator core 21 of the stator 20 of the superconducting motor 2. The refrigerator 30 desirably includes a compressor for compressing a refrigerant gas, a heat radiator for emitting a compression heat that has been generated when the refrigerant gas is compressed, and the like. A known refrigerator such as a pulse tube refrigerator, Stirling refrigerator, Gifford-McMahon refrigerator, Solvay refrigerator, and Vuilleumier refrigerator may be used as the refrigerator 30.

The conductive portion 33, which is arranged between the superconducting motor 2 and the refrigerator 30, is made of a material having a temperature conductivity (thermal conductivity) such as copper, copper alloy, aluminum, and aluminum alloy. For example, the conductive portion 33 may be constituted by a member including at least one of a wire rod, a fibrous material, and a granular material as a base material. Such member has a vibration absorption performance and therefore prevents a vibration of the superconducting motor 2 and/or an external vibration from being transmitted to the refrigerator 30. The member functions as a kind of vibration damping elements.

As illustrated in FIG. 1, the container 4 includes a vacuum heat insulation chamber 40 serving as a decompressed heat insulation chamber for heat-insulating the superconducting coil 22. At this time, the term “vacuum” corresponds to a decompressed state or a vacuum state in which a greater heat insulation is achieved as compared to atmosphere, i.e., a state equal to or smaller than 10⁻¹ Pa, equal to or smaller than 10⁻² Pa, and the like. The vacuum heat insulation chamber 40 of the container 4 includes an outer vacuum heat insulation chamber 41 and an inner vacuum heat insulation chamber 42. The outer vacuum heat insulation chamber 41 covers an outer peripheral side (outer side) of the superconducting coil 22 wound on the stator 20 and held thereby and an outer peripheral side (outer side) of the stator 20. The inner vacuum heat insulation chamber 42 covers an inner peripheral side (inner side) of the superconducting coil 22 and an inner peripheral side (inner side) of the stator 20. The vacuum heat insulation chamber 40 is maintained in a high vacuum state (i.e., in a state to be decompressed relative to an atmospheric pressure) upon shipment. The vacuum heat insulation chamber 40 is desirably maintained in the high vacuum state over a long period of time.

Because the superconducting coil 22 is covered by both the outer vacuum heat insulation chamber 41 and the inner vacuum heat insulation chamber 42, the superconducting coil 22 is maintained in an extremely low temperature state, and further in a superconducting state. As illustrated in FIG. 1, the outer vacuum heat insulation chamber 41 includes a first insulation chamber portion 41a covering an outer peripheral portion of the stator 20 and a second insulation chamber portion 41 c (intermediate vacuum heat insulation chamber) covering outer peripheral portions of the conductive portion 33 and the cold head 32. The second insulation chamber portion 41c covers the conductive portion 33 and the cold head 32 in a coaxial manner, thereby maintaining the conductive portion 33 and the cold head 32 at a low temperature.

As illustrated in FIG. 1, the container 4 includes a first container 43, a second container 44, a third container 45, and a fourth container 46 in order from a radially outer side to a radially inner side. The first to fourth containers 43 to 46 are coaxially arranged with one another. The first container 43 and the second container 44 face each other in a radial direction of the stator core 21 so as to define the outer vacuum heat insulation chamber 41. The third container 45 and the fourth container 46 face each other in the radial direction of the stator core 21 so as to define the inner vacuum heat insulation chamber 42.

The rotor 27 is rotatably arranged in a void 47 having a cylindrical shape defined by the fourth container 46. The void 47 is connected to an outer atmosphere. The rotor 27 is connected to a rotating operation member, which is a wheel, for example, in a case where the superconducting motor device 1 is mounted on a vehicle such as an automobile. In such case, when the rotor 27 rotates, the wheel rotates accordingly.

As illustrated in FIG. 1, the first container 43 includes a first cover portion 431 (an outer container), a guide portion 433, a second cover portion 434 (an intermediate container), and an attachment flange portion 435. The first cover portion 431 having a cylindrical shape covers an outer peripheral portion of the superconducting motor 2. The guide portion 433 defines a guide chamber 432 for guiding three-phase electric current lead-in wires 56 (which will be hereinafter referred to as lead-in wires 56) that supply an electric power to the superconducting coil 22. The second cover portion 434 is arranged between the first cover portion 431 and the refrigerator 30 (extremely low temperature generating portion 3) while surrounding the cold head 32 and the conductive portion 33. A flange 30c of a compression mechanism 30a that compresses a refrigerant gas in the refrigerator 30 is mounted on the attachment flange portion 435. The guide portion 433 is formed, projecting from the first cover portion 431 that covers the superconducting motor 2. An outer side of the first container 43 may be exposed to the outer atmosphere but not limited thereto. The outer side of the first container 43 may be covered by a heat insulation material.

The first container 43 is made of a material desirably having a strength and through which leakage flux does not penetrate or is difficult to penetrate. A nonmagnetic metal having a low permeability such as an alloy steel, i.e., an austenitic stainless steel, is used for the material of the first container 43, for example. Each of the second, third, and fourth containers 44, 45, and 46 is made of a material desirably having a high electric resistance so that a magnetic flux may penetrate through the second, third and fourth containers 44, 45, and 46 but so as to restrain eddy current that may be generated on the basis of change in magnetic flux. A nonmetallic material such as resin, reinforced resin for a reinforcing material, and ceramic is used for the material forming the second to fourth containers 44, 45 and 46, for example. The reinforcing material is a mineral material such as glass and ceramic, for example. The reinforcing material is desirably a reinforced fiber and is an inorganic fiber such as a glass fiber and a ceramic fiber. The resin may be either a thermosetting resin or a thermoplastic resin.

As illustrated in FIG. 1, a fixed board 70 serving as a holding portion is fixed to an upper end of the guide portion 433 that has a cylindrical shape formed at a portion of the first container 43 in a projecting manner. The fixed board 70 is made of a material having a high heat insulation and/or difficulty in permeation of leakage flux. For example, a nonmetallic material such as a fiber-reinforced resin (reinforced resin for reinforcing material), resin, and ceramic may be used for the material forming the fixed board 70. A nonmagnetic metallic material having a low permeability may be used for the material as the need may be. In such case, an electric insulation structure is desirably applied to each of the lead-in terminals 5.

The guide chamber 432 is connected to the outer vacuum heat insulation chamber 41. Thus, in a case where the superconducting motor 2 is driven, the guide chamber 432 is in the vacuum insulation state (i.e., decompressed heat insulation state). The guide chamber 432 exercises the heat insulation function to thereby maintain the lead-in terminals 5 at the low temperature.

As illustrated in FIG. 1, the multiple (three) lead-in terminals 5 are electrically connected to the superconducting coil 22 via the respective lead-in wires 56. The lead-in terminals 5 include a conductive material as a base material through which an electric power is supplied to the superconducting coil 22. The lead-in terminals 5 are fixedly arranged at the fixed board 70 provided at the end of the guide portion 433 of the first container 43. First ends of the lead-in terminals 5 are accommodated within the guide chamber 432 while second ends (i.e., end portions 85) of the lead-in terminals 5 are positioned so as to protrude out of the guide chamber 432. A material forming the lead-in terminals 5 is not specifically defined as long as the material is conductive. For example, copper, copper alloy, aluminum, aluminum alloy, iron, iron alloy, silver, or silver alloy may be used for the material forming the lead-in terminals 5.

When a change-over switch is turned on, the three-phase alternating current is supplied from an external electric power source to the lead-in terminals 5 and further to the superconducting coil 22. Then, the rotational magnetic field (movable magnetic field) is generated around the axial center P1 of the superconducting motor 2 to thereby rotate the rotor 27 about the axial center P1. The superconducting motor 2 is driven accordingly. The magnetic flux penetrates through the third container 45, the inner vacuum heat insulation chamber 42, and the fourth container 46, thereby generating an attraction force and a repelling force at the permanent magnet portions 29 of the rotor 27. The rotor 27 rotates about the axial center P1 accordingly. When the superconducting motor 2 is driven, the superconducting coil 22 and the stator core 21 are maintained at the extremely low temperature that is generated by the extremely low temperature generating portion 3. Thus, the superconducting state of the superconducting coil 22 is excellently maintained, which leads to an excellent rotational driving of the superconducting motor 2. Because the electric resistance of the superconducting coil 22 is equal to zero or extremely low, the output of the superconducting motor 2 is high. On the other hand, when the driving of the superconducting motor 2 is stopped, the change-over switch is turned off. The lead-in terminals 5 of the fixed board 70 and the external power source are electrically separated from each other accordingly.

A main portion of the present embodiment will be explained with reference to FIG. 2. As illustrated in FIG. 2, vibration damping elements 100A are provided. Each of the vibration damping elements 100A constitutes a fluid damper exercising a vibration damping function for restraining a vibration generated by the superconducting motor 2 and/or an external vibration from being propagated to the refrigerator 30.

As illustrated in FIG. 2, the vibration damping elements 100A are arranged between the first cover portion 431 of the container 4 and the refrigerator 30. Specifically, the vibration damping elements 100A are arranged at a radially outer side of the second cover portion (intermediate container) 434. That is, the vibration damping elements 100A are arranged in an atmospheric region at a substantially normal temperature. The multiple vibration damping elements 100A are arranged, having equal distances therebetween, around an axial center P3 of the cold head 32 in a circumferential direction thereof. Each of the vibration damping elements 100A includes a cylindrical body 102, a movable body 106, and a connection passage 108. The cylindrical body 102 includes a hollow chamber 101 and an axial center P4. The movable body 106 is movably arranged within the hollow chamber 101 of the cylindrical body 102 so as to divide the hollow chamber 101 into a first fluid chamber 103f and a second fluid chamber 103s. The connection passage 108 connects the first fluid chamber 103f and the second fluid chamber 103s so as to dampen or attenuate the vibration by moving a fluid between the first fluid chamber 103f and the second fluid chamber 103s in association with a movement of the movable body 106.

As illustrated in FIG. 2, the movable body 106 is held by the first cover portion 431 of the container 4. The cylindrical body 102 further includes a motor-side cylinder portion 110 fixed to the first cover portion 431 of the container 4, a refrigerator-side cylinder portion 111 fixed to the refrigerator 30, and an accordion cylinder portion 121 having an accordion portion 120 that is connected between the motor-side cylinder portion 110 and the refrigerator-side cylinder portion 111 and that is stretchable along an axial length of the cylindrical body 102.

The connection passage 108 is constituted by a small clearance that is formed between a head portion provided at an end of the movable body 106 and the refrigerator-side cylinder portion 111. The connection passage 108 serves as a throttle bore for reducing a flowing amount of fluid. The motor-side cylinder portion 110, the refrigerator-side cylinder portion 111, and the connection passage 108 are formed around the axial center P4 of the vibration damping element 100A so as to be coaxial therewith. A fluid is enclosed in the hollow chamber 101. Gas, liquid, or the like is used as the fluid. Air, nitrogen gas, or helium gas is used as gas, for example. Because the vibration damping elements 100A are arranged in a substantially normal temperature range, maintenance of the vibration damping elements 100A is easy and solidification of fluid caused by freezing temperatures is unlikely to occur. As a result, air or nitrogen gas is used as gas, for example. In addition, oil or water is used as liquid, for example.

The vibration generated by the rotational driving of the superconducting motor 2 and/or the external vibration is likely to be propagated to the refrigerator 30. Then, in association with such vibration, the movable body 106 reciprocates in a vibrating manner within the hollow chamber 101 along the axial center P4. At this time, when the movable body 106 moves towards the refrigerator 30, the pressure in the first fluid chamber 103f increases while the pressure in the second fluid chamber 103s decreases. The fluid within the hollow chamber 101 thus moves from the first fluid chamber 103f through the connection passage 108 to the second fluid chamber 103s. In addition, when the movable body 106 moves towards the superconducting motor 2, the pressure in the second fluid chamber 103s increases while the pressure in the first fluid chamber 103f decreases. The fluid within the hollow chamber 101 then moves from the second fluid chamber 103s through the connection passage 108 to the first fluid chamber 103f. Accordingly, a vibrational energy is repeatedly consumed as a kinetic energy of the fluid, thereby attenuating or damping the vibration from the superconducting motor 2 towards the refrigerator 30. The durability and long life of the refrigerator 30 are ensured accordingly. A harmful vibration propagated to the refrigerator 30 may be a cause of a decrease in output of the refrigerator 30.

As illustrated in FIG. 2, the multiple vibration damping elements 100A are arranged, having equal distances therebetween, around the axial center P3 of the cold head 32 in the circumferential direction thereof. Thus, because the multiple vibration damping elements 100A are arranged at positions so as to surround the second cover portion (intermediate container) 434 that accommodates the cold head 32 and the conductive portion 33, the refrigerator 30 is protected from the harmful vibration. Further, the vibration is effectively restrained from being generated at the cold head 32 and the conductive portion 33 both of which serve as important members for temperature conductivity.

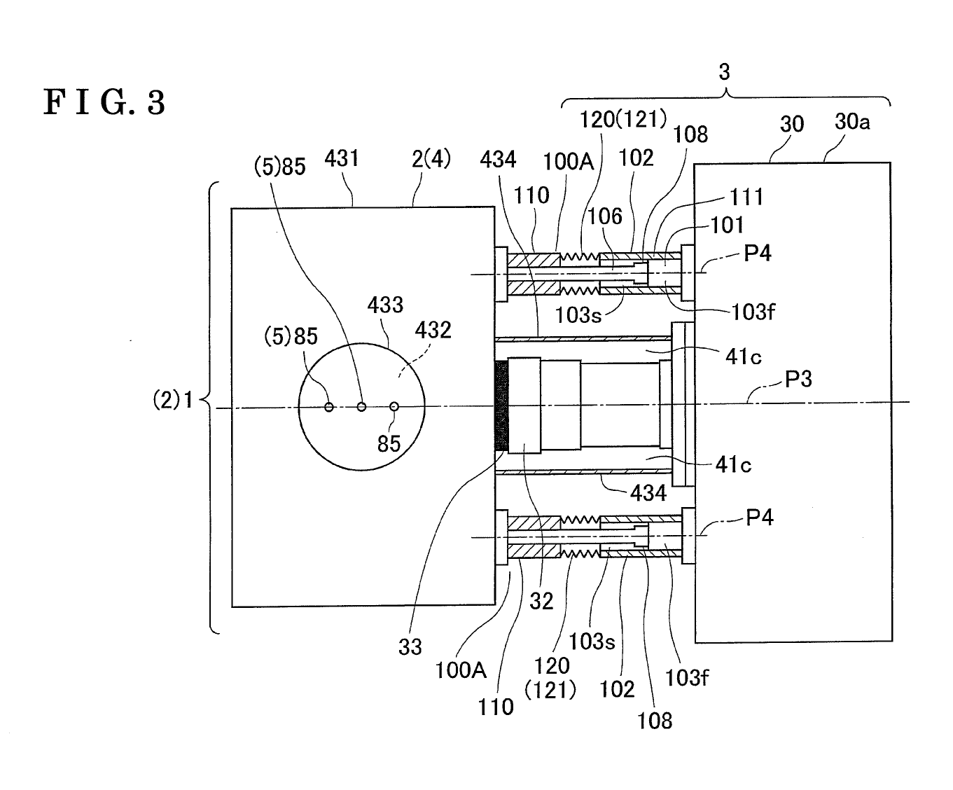

A second embodiment will be explained with reference to FIG. 3. The second embodiment basically includes the same structures and effects as those of the first embodiment. Differences of the second embodiment from the first embodiment will be mainly described below. According to the second embodiment as illustrated in FIG. 3, a single vibration damping element 100B is arranged between the first cover portion 431 of the container 4 and the refrigerator 30. Specifically, the vibration damping element 100B is positioned at a radially outer side of the second cover portion (intermediate container) 434 and is arranged in an atmospheric region at a substantially normal temperature.

The vibration damping element 100B is arranged in a cylindrical shape around the axial center P3 of the cold head 32 so as to be coaxial therewith. The vibration damping element 100B includes the cylindrical body 102, the movable body 106 having a piston shape, and the connection passage 108. The cylindrical body 102 includes the hollow chamber 101 having a ring shape surrounding the second cover portion 434 about the axial center P3. The movable body 106 is movably arranged within the hollow chamber 101 of the cylindrical body 102 so as to divide the hollow chamber 101 into the first fluid chamber 103f and the second fluid chamber 103s. The connection passage 108 connects the first fluid chamber 103f and the second fluid chamber 103s so as to dampen the vibration by moving the fluid between the first fluid chamber 103f and the second fluid chamber 103s in association with a movement of the movable body 106. The motor-side cylinder portion 110, the refrigerator-side cylinder portion 111, the movable body 106, and the connection passage 108 are each formed into a cylindrical shape about the axial center P3 of the cold head 32. Because the vibration damping element 100B is formed into a cylindrical shape about the axial center P3 of the cold head 32, the refrigerator 30 is protected and the vibration is effectively restrained from being generated at the cold head 32 and at the conductive portion 33, both of which serve as important members for temperature conductivity.

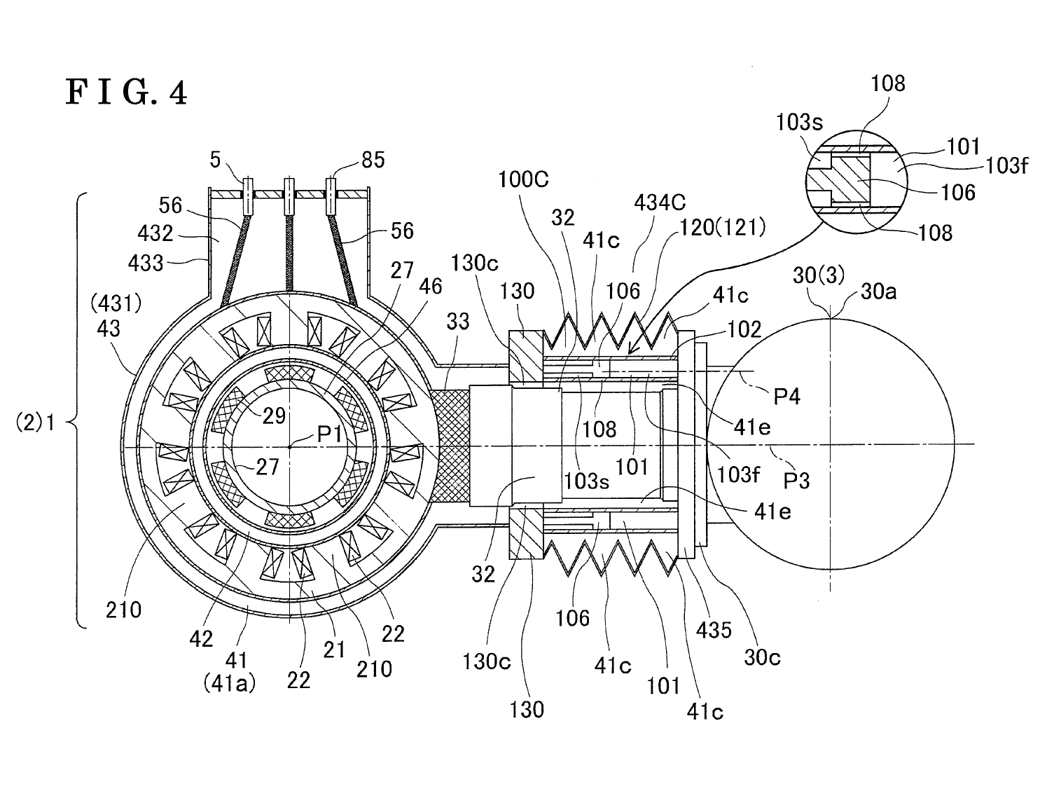

A third embodiment will be explained with reference to FIG. 4. The third embodiment basically includes the same structures and effects as those of the first embodiment. Differences of the third embodiment from the first embodiment will be mainly described below. As illustrated in FIG. 4, a second cover portion (intermediate container) 434C is arranged between the superconducting motor 2 and the refrigerator 30 while being connected to the first cover portion 431 of the container 4. The second cover portion 434C includes a ring member 130 in a fixed state and the accordion cylinder portion 121. The ring member 130 surrounds the cold head 32 via a ring-shaped clearance 130c. The accordion cylinder portion 121 includes the accordion portion 120 connected to the ring member 130. One end of the accordion cylinder portion 121 in a length direction thereof is connected to the ring member 130 while the other end of the accordion cylinder portion 121 in the length direction thereof is connected to the flange 30c of the refrigerator 30.

As illustrated in FIG. 4, vibration damping elements 100C are arranged within the second insulation chamber portion 41c of the second cover portion 434C. Specifically, the multiple vibration damping elements 100C are arranged, having equal distances therebetween, around the axial center P3 of the cold head 32 in the circumferential direction thereof. Each of the vibration damping elements 100C includes the cylindrical body 102, the movable body 106, and the connection passage 108. The cylindrical body 102 includes the axial center P4 and the hollow chamber 101 held by the ring member 130. The movable body 106 having a piston shape is movably arranged within the hollow chamber 101 of the cylindrical body 102 so as to divide the hollow chamber 101 into the first fluid chamber 103f and the second fluid chamber 103s. The connection passage 108 connects the first fluid chamber 103f and the second fluid chamber 103s so as to serve as a fluid throttle bore.

As illustrated in FIG. 4, the connection passage 108 is formed around the axial center P4 and is constituted by a small clearance serving as a throttle bore that is defined between the head portion at an end of the movable body 106 and the cylindrical body 102. A fluid is enclosed in the hollow chamber 101. Gas, liquid, or the like is used as the fluid. Air, nitrogen gas, or helium gas is used as gas, for example. Oil is used as liquid, for example. The fluid within the hollow chamber 101 that constitutes the vibration damping element 100C is surrounded by the accordion cylinder portion 121 and the second insulation chamber portion 41c provided at a radially inner side of the accordion cylinder portion 121. Thus, the heat outside of the accordion cylinder portion 121 is prevented from being transmitted to the fluid within the hollow chamber 101.

A heat insulation chamber portion 41e is formed at a radially inner side of the vibration damping element 100C. Thus, the hollow chamber 101 is positioned away from the cold head 32. The hollow chamber 101 is unlikely to be directly influenced by the extremely low temperature of the cold head 32 accordingly. The fluid enclosed in the hollow chamber 101 of the cylindrical body 102 is prevented from being frozen and solidified. Thus, oil, air, or nitrogen gas is used as fluid enclosed in the hollow chamber 101, for example. In a case where the fluid enclosed in the hollow chamber 101 of the cylindrical body 102 is retained at a low temperature, a helium gas, which is unlikely to be solidified, is used as fluid, for example.

The vibration generated by the rotational driving of the superconducting motor 2 and/or the external vibration via the superconducting motor 2 is likely to be propagated to the refrigerator 30. At this time, in association with such vibration, the movable body 106 reciprocates within the hollow chamber 101. Then, when the movable body 106 moves towards the refrigerator 30, the pressure in the first fluid chamber 103f increases while the pressure in the second fluid chamber 103s decreases. The fluid within the hollow chamber 101 then moves from the first fluid chamber 103f through the connection passage 108 to the second fluid chamber 103s. In addition, when the movable body 106 moves towards the superconducting motor 2, the pressure in the second fluid chamber 103s increases while the pressure in the first fluid chamber 103f decreases. The fluid within the hollow chamber 101 then moves from the second fluid chamber 103s through the connection passage 108 to the first fluid chamber 103f. Accordingly, a vibrational energy is consumed as a kinetic energy of the fluid, thereby damping the vibration from the superconducting motor 2 towards the refrigerator 30. As illustrated in FIG. 4, since the multiple vibration damping elements 100C are arranged around the axial center P4, the vibration transmitted from the superconducting motor 2 to the refrigerator 30 is effectively attenuated.

As illustrated in FIG. 4, the clearance 130c is formed between the ring member 130 and the cold head 32 into a ring shape around the axial center P3 of the cold head 32. The clearance 130c serves as a vacuum heat insulation chamber portion. The ring member 130 and the cold head 32 are therefore retained in a disconnection state. The extremely low temperature of the cold head 32 is restrained from being directly transmitted to the ring member 130. As a result, the low temperature state of the cold head 32 is maintained to thereby retain the superconducting coil 22 in the extremely cold temperature state. Further, because of the clearance 130c serving as the vacuum heat insulation chamber portion, the low temperature of the cold head 32 is restrained from being transmitted to the fluid within the hollow chamber 101 via the ring member 130. The solidification of the fluid within the hollow chamber 101 caused by the freezing temperature is restrained. Therefore, the fluid for damping is positioned close to the cold head 32 but fluidity is ensured. The damper function obtained by a flow of the fluid within the hollow chamber 101 is still ensured.

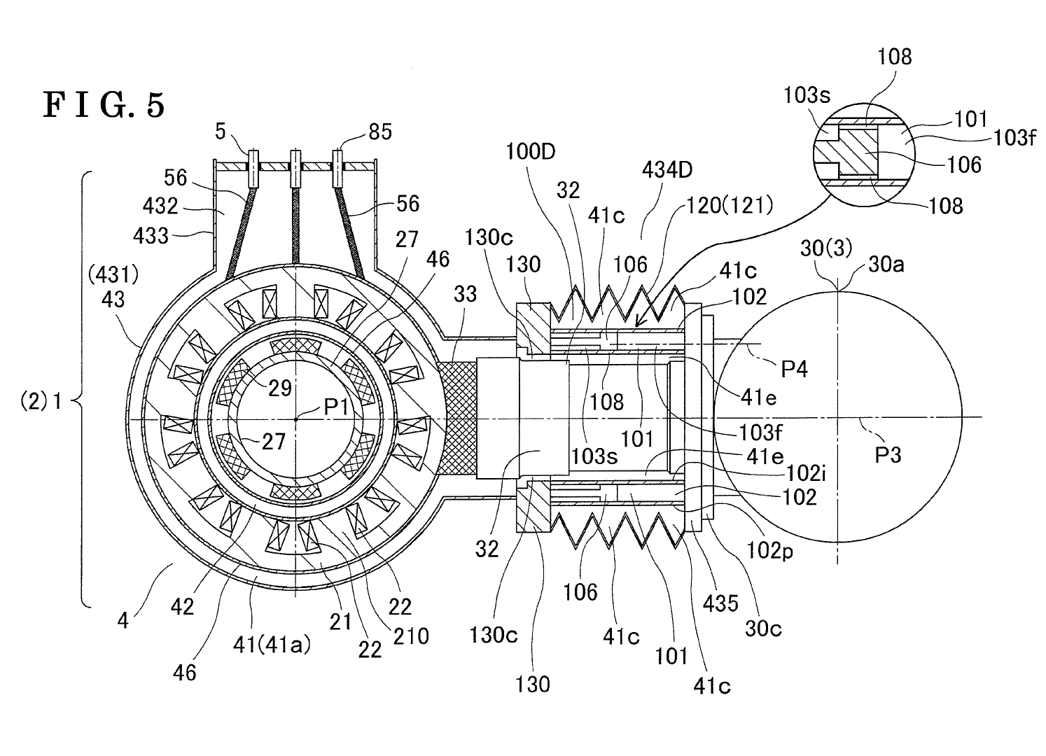

A fourth embodiment will be explained with reference to FIG. 5. The fourth embodiment basically includes the same structures and effects as those according to the first embodiment. Differences of the fourth embodiment from the first embodiment will be mainly described below. As illustrated in FIG. 5, a second cover portion (intermediate container) 434D is arranged between the superconducting motor 2 and the refrigerator 30. The second cover portion 434D includes the ring member 130 covering the cold head 32 via the ring-shaped clearance 130c and the accordion cylinder portion 121 having the accordion portion 120 connected to the ring member 130. One end of the accordion cylinder portion 121 in the length direction thereof is connected to the ring member 130 while the other end of the accordion cylinder portion 121 is connected to the flange 30c of the refrigerator 30.

As illustrated in FIG. 5, a single vibration damping element 100D includes the cylindrical body 102 having the hollow chamber 101 retained by the ring member 130, the movable body 106 having a piston shape and movably arranged within the hollow chamber 101 of the cylindrical body 102 so as to divide the hollow chamber 101 into the first fluid chamber 103f and the second fluid chamber 103s, and the connection passage 108 connecting the first fluid chamber 103f and the second fluid chamber 103s. The cylindrical body 102 includes an inner cylinder 102i and an outer cylinder 102p so as to cover the cold head 32 to be coaxial therewith. The movable body 106 is formed into a cylindrical shape for surrounding the cold head 32.

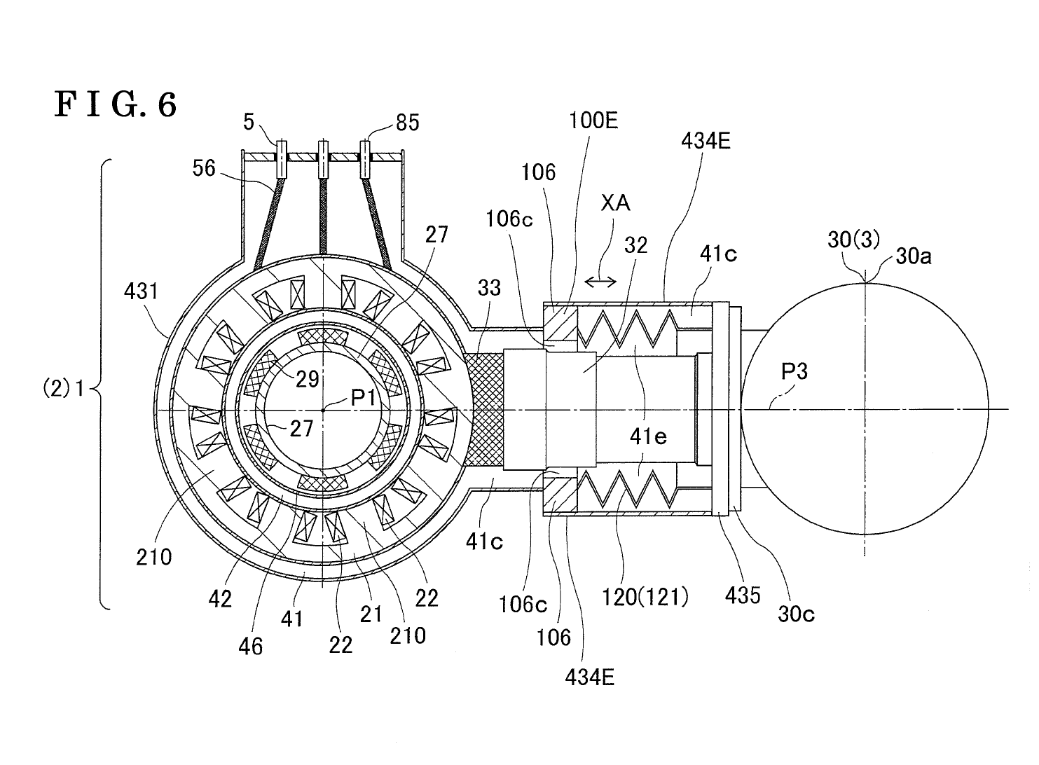

A fifth embodiment will be explained with reference to FIG. 6. The fifth embodiment basically includes the same structures and effects as those according to the first embodiment. Differences of the fifth embodiment from the first embodiment will be mainly described below. A second cover portion (intermediate container) 434E is arranged between the superconducting motor 2 and the refrigerator 30 while being connected to the first cover portion 431 of the first container 43. The second cover portion 434E covers an outer peripheral surface of the cold head 32 so as to be coaxial therewith. A vibration damping element 100E is held in the second insulation chamber portion 41c formed inside of the second cover portion 434E.

As illustrated in FIG. 6, the vibration damping element 100E includes the movable body 106 having a ring shape and surrounding the cold head 32 via a clearance 106c, and the accordion cylinder portion 121 made of metal and having the stretchable accordion portion 120 connected to the movable body 106. The movable body 106 and the cold head 32 are retained in a disconnection state via the clearance 106c to thereby prevent the low temperature of the cold head 32 from being directly transmitted to the movable body 106. As a result, the cooling of the superconducting coil 22 is enhanced.

The movable body 106 and the accordion cylinder portion 121 are provided around the axial center P3 of the cold head 32 so as to be coaxial therewith. One end of the accordion cylinder portion 121 in the length direction thereof is connected to the movable body 106. The other end of the accordion cylinder portion 121 in the length direction thereof is connected to the flange 30c of the refrigerator 30. The movable body 106 is made of either resin, metal, or ceramic.

The vibration generated by the rotational driving of the superconducting motor 2 and/or the external vibration is likely to be propagated to the refrigerator 30. Then, within the second cover portion (intermediate container) 434E, the vibrational energy of the superconducting motor 2 is consumed and damped by means of the vibration or movement of the movable body 106 in an arrow direction XA that occurs in association with the vibration of the superconducting motor 2. In association with the vibration of the movable body 106, the accordion portion 120 of the accordion cylinder portion 121 functions as a shock absorbing spring so as to repeat expansion and contraction. Accordingly, the vibration generated by the rotational driving of the superconducting motor 2 and/or the external vibration via the superconducting motor 2 is further consumed and attenuated.

In a case where the accordion cylinder portion 121 is accommodated in gas such as air, the gas provided in the vicinity of the accordion cylinder portion 121 may function as resistance, depending on a thickness of a wall of the accordion cylinder portion 121, for example, in a case where the accordion cylinder portion 121 is deformed by expansion and contraction. Then, the smooth expansion and contraction of the accordion cylinder portion 121 may be deteriorated and further the vibration absorption performance of the accordion cylinder portion 121 may decrease. However, according to the present embodiment, the accordion cylinder portion 121 is surrounded by the second insulation chamber portion 41c (intermediate vacuum heat insulation chamber) and the heat insulation chamber portion 41e. Thus, when the accordion cylinder portion 121 is deformed by expansion and contraction, an area around the accordion cylinder portion 121 is in the high vacuum state. Gas that serves as a deformation resistance is not present so that the excellent expansion and contraction deformation of the accordion cylinder portion 121 is ensured. Further, because the accordion cylinder portion 121 is disconnected from the cold head 32 by means of the heat insulation chamber portion 41e, an excessive low temperature of the accordion cylinder portion 121 is restrained, thereby ensuring expansion and contraction of the accordion cylinder portion 121.

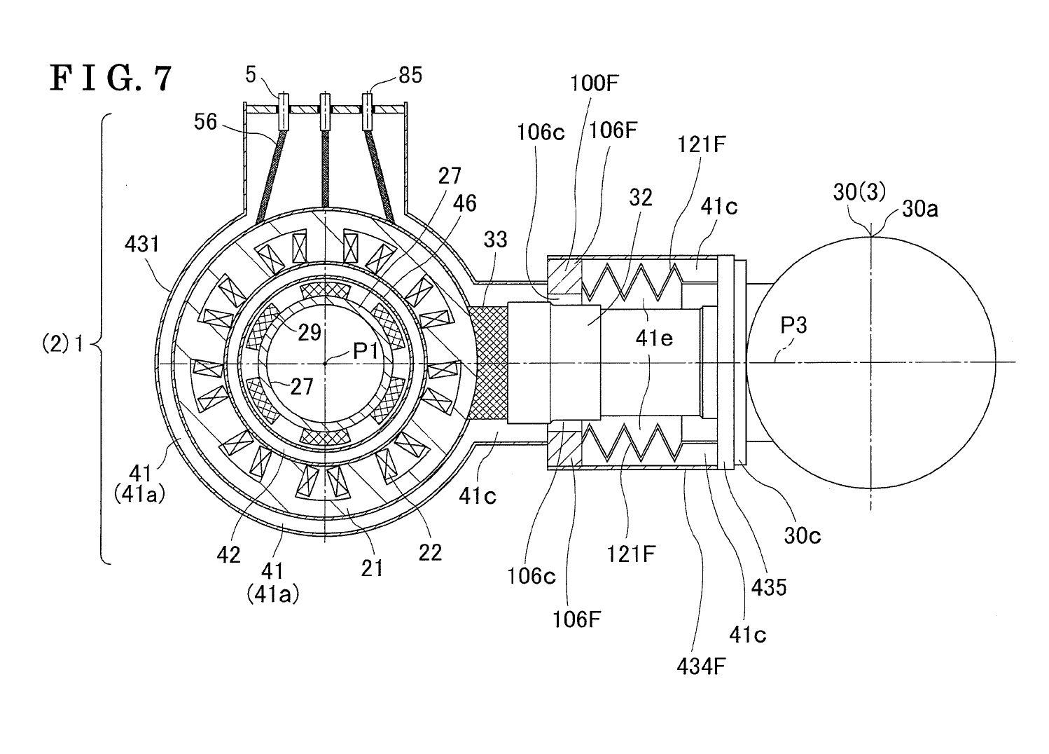

A sixth embodiment will be explained with reference to FIG. 7. The sixth embodiment basically includes the same structures and effects as those according to the fifth embodiment. Differences of the sixth embodiment from the fifth embodiment will be mainly described below. According to the sixth embodiment, a vibration damping element 100F serves as a dynamic damper. The vibration damping element 100F is accommodated within the second insulation chamber portion 41c of a second cover portion (intermediate container) 434F. Specifically, the vibration damping element 100F includes a mass body 106F serving as a ring-shaped movable body that surrounds the cold head 32 to be coaxial therewith via the clearance 106c for heat insulation, and a spring portion 121F having a coil shape for elastically supporting the mass body 106F. The mass body 106F and the cold head 32 are maintained in a disconnection state by means of the clearance 106c so that the low temperature of the cold head 32 is prevented from being transmitted to the mass body 106F. As a result, the cooling of the superconducting coil 22 is enhanced.

A tuning frequency (natural frequency) of the dynamic damper is basically determined on the basis of a mass of the mass body 106F and a spring constant of the spring portion 121F. By correlating a frequency region where a harmful vibration of a vibrating member is desired to be prevented with the tuning frequency region of the dynamic damper, the vibrational energy is consumed in the frequency region, where the vibration is desired to be prevented, by means of resonance of the dynamic damper, thereby preventing the harmful vibration from being propagated to the refrigerator 30. According to the present embodiment, the mass body 106F and the spring portion 121F are arranged within the second insulation chamber portion 41c (intermediate vacuum heat insulation chamber), which results in no air resistance. Further, because the spring portion 121 F is disconnected from the cold head 32 by means of the heat insulation chamber portion 41 e, the excessive low temperature of the spring portion 121F is prevented. The spring constant of the spring portion 121F is prevented from being directly influenced by the cold temperature of the cold head 32. Therefore, it is favorable to obtain vibration damping function that follows the tuning of the dynamic damper. As the need may be, the spring portion 121F may have an accordion structure.

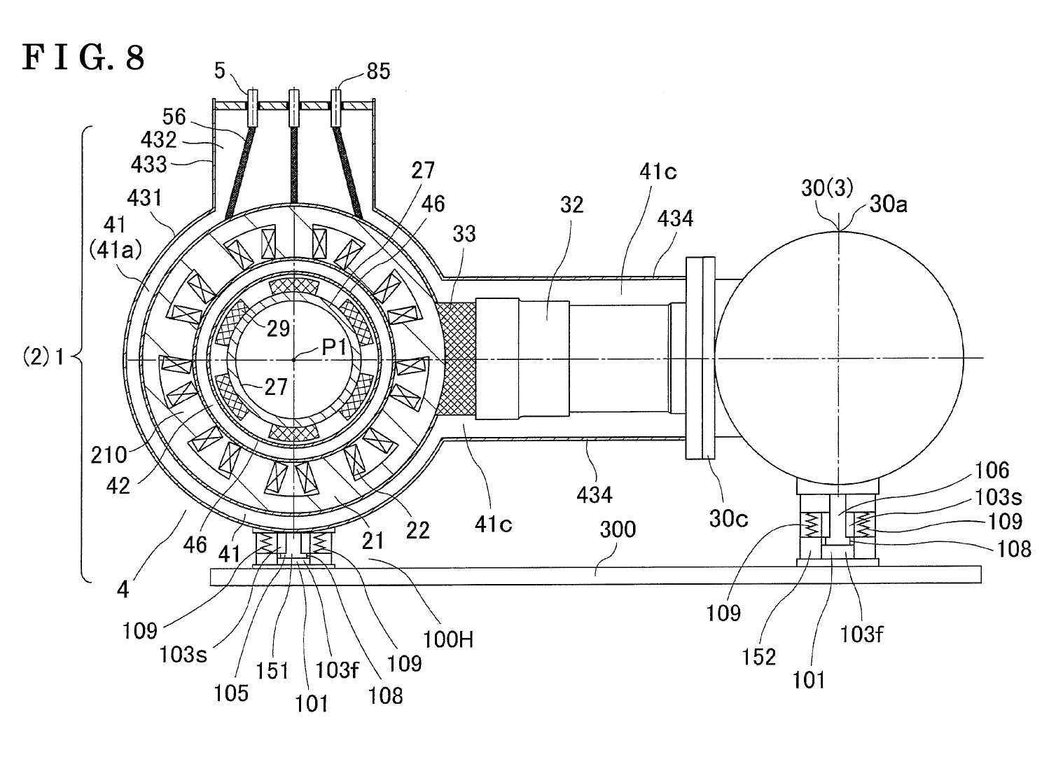

A seventh embodiment will be explained with reference to FIG. 8. The seventh embodiment basically includes the same structures and effects as those according to the first embodiment. Differences of the seventh embodiment from the first embodiment will be mainly described below. According to the seventh embodiment, a vibration damping element 100H includes a first damping element 151 elastically supporting the superconducting motor 2 and a second damping element 152 elastically supporting the refrigerator 30. The first damping element 151 is arranged between the first cover portion 431 that accommodates the superconducting motor 2 and the frame 300 of a vehicle, and the like. The first damping element 151 elastically supports a lower portion of the first cover portion 431. The frame 300 may serve as a vibration propagation factor for propagating the vibration of the vehicle, the external vibration, and the like to the superconducting motor 2. In addition, the frame 300 may be the vibration propagation factor for propagating the vibration of the superconducting motor 2, the external vibration, and the like to the refrigerator 30.

The first damping element 151 includes a fluid damper and a mechanical damper. The fluid damper of the first damping element 151 includes the hollow chamber 101 where the fluid is enclosed, the piston-shaped movable body 106 that divides the hollow chamber 101 into the first fluid chamber 103f and the second fluid chamber 103s, and the connection passage 108 that connects the first fluid chamber 103f and the second fluid chamber 103s. The mechanical damper includes a shock absorbing spring 109 formed by a coil spring, or the like.

In the fluid damper, in a case where the vibration is generated by the rotational driving of the superconducting motor 2 and/or the external vibration is generated, the movable body 106 moves in a vibrating manner within the hollow chamber 101. As a result, an operation in which the pressure in the first fluid chamber 103f increases while the pressure in the second fluid chamber 103s decreases and an operation in which the pressure in the second fluid chamber 103s increases while the pressure in the first fluid chamber 103f decreases are repeated. The fluid within the hollow chamber 101 reciprocates between the first fluid chamber 103f and the second fluid chamber 103s. Accordingly, the vibrational energy is repeatedly consumed as a kinetic energy of the fluid, thereby damping the vibration from the superconducting motor 2 towards the refrigerator 30. The shock absorbing spring 109 constituting the mechanical damper attenuates the vibrational energy by elastically deforming.

As illustrated in FIG. 8, the second damping element 152 has substantially the same structure as that of the first damping element 151. That is, the second damping element 152 includes the fluid damper and the mechanical damper. The fluid damper of the second damping element 152 includes the hollow chamber 101 in which the fluid is enclosed, the piston-shaped movable body 106 that divides the hollow chamber 101 into the first fluid chamber 103f and the second fluid chamber 103s, and the connection passage 108 that connects the first fluid chamber 103f and the second fluid chamber 103s. The mechanical damper includes the shock absorbing spring 109 formed by a coil spring, or the like. In the fluid damper of the second damping element 152, in a case where the vibration is generated by the rotational driving of the superconducting motor 2 and/or the external vibration is generated, the movable body 106 moves in a vibrating manner within the hollow chamber 101. As a result, an operation in which the pressure in the first fluid chamber 103f increases while the pressure in the second fluid chamber 103s decreases and an operation in which the pressure in the second fluid chamber 103s increases while the pressure in the first fluid chamber 103f decreases are repeated. The fluid within the hollow chamber 101 reciprocates between the first fluid chamber 103f and the second fluid chamber 103s. Accordingly, the vibrational energy is repeatedly consumed as a kinetic energy of the fluid, thereby attenuating the vibration propagated to the refrigerator 30 from the superconducting motor 2. The shock absorbing spring 109 constituting the mechanical damper attenuates the vibrational energy by elastically deforming.

The first to seventh embodiments are not limited to have the aforementioned structures and may be appropriately modified or changed. A specific structure or function for one of the embodiments may be applicable to the other of the embodiments.

According to the aforementioned embodiments, the vibration damping element 100A, 100B, 100C, 100D, 100E, 100F, 100H restrains the vibration of the superconducting motor 2 and/or the external vibration from being propagated to the extremely low temperature generating portion 3, thereby improving durability and lifetime of the extremely low temperature generating portion 3.

According to the aforementioned embodiments, the superconducting motor 2 includes the rotor (mover) 27 that is rotatable (movable) on the basis of a movable magnetic field that is generated by the superconducting coil 22 when an electric power is supplied thereto. The superconducting motor 2 includes the stator 20 and the rotor 27. The superconducting coil 22 may be provided at either the stator 20 or the rotor 27. The superconducting motor 2 may be a known motor such as a DC (direct-current) motor and a synchronous motor. Alternatively, the superconducting motor 2 may be a rotation motor, a linear motor, and the like.

The container 4 defines the outer vacuum heat insulation chamber 41 that covers at least an outer side of the superconducting motor 2. The extremely low temperature generating portion 3 is defined to cool the superconducting coil 22 of the superconducting motor 2 to a temperature equal to or smaller than a critical temperature of the superconducting coil 22. The critical temperature corresponds to a temperature at which a superconducting material constituting the superconducting coil 22 indicates a superconducting state while the temperature is decreasing. The critical temperature is defined depending on a composition of the superconducting material. The extremely low temperature generating portion 3 may be a refrigerator, or a refrigerant container storing a refrigerant such as liquid nitrogen, liquid air, and helium in an extremely low temperature state.

The vibration damping element 100A, 1008, 100C, 100D, 100E, 100F, 100H is defined to restrain the vibration of the superconducting motor 2 and/or the external vibration from being propagated to the extremely low temperature generating portion 3. For example, the vibration damping element 100A, 100B, 100C, 100D, 100E, 100F, 100H may be a fluid damper using a kinetic energy of a fluid, a mechanical damper using a buffer action of a mechanical spring, a dynamic damper using resonance, or the like.

According to the aforementioned first to fourth embodiments, the vibration damping element 100A, 100B, 100C, 100D includes the cylindrical body 102 arranged between the container 4 and the extremely low temperature generating portion 3 and including the hollow chamber 101, the movable body 106 movably arranged in the hollow chamber 101 to divide the hollow chamber 101 into the first and second fluid chambers 103f and 103s, and the connection passage 108 connecting the first and second fluid chambers 103f and 103s to one another for attenuating the vibration by a movement of the fluid among the fluid chambers 103f and 103s in association with a movement of the movable body 106.

Accordingly, in association with the movement of the movable body 106, the fluid moves between the fluid chambers 103f and 103s to thereby consume the vibrational energy to attenuate the vibration.

According to the aforementioned third to sixth embodiments, the container 4 includes the first cover portion (outer container) 431 defining the outer vacuum heat insulation chamber 41 that covers the outer side of the superconducting motor 2 and the second cover portion (intermediate container) 434C, 434D, 434E, 434F defining the second insulation chamber portion (intermediate vacuum heat insulation chamber) 41c that covers the cold head 32 of the extremely low temperature generating portion 3 and arranged between the first cover portion (outer container) 431 and the extremely low temperature generating portion 3 and wherein the vibration damping element 100C, 100D, 100E, 100F is arranged within the second insulation chamber portion (intermediate vacuum heat insulation chamber) 41c of the second cover portion (intermediate container) 434C, 434D, 434E, 434F.

Because the vibration damping element 100C, 100D, 100E, 100F is arranged within the second insulation chamber portion (intermediate vacuum heat insulation chamber) 41c of the second cover portion (intermediate container) 434C, 434D, 434E, 434F, the vibration damping element 100C, 100D, 100E, 100F is maintained at a lower temperature than the normal temperature.

According to the aforementioned fifth and sixth embodiments, the vibration damping element 100E, 100F includes the movable body 106, 106F arranged within the second insulation chamber portion (intermediate vacuum heat insulation chamber) 41c of the second cover portion (intermediate container) 434E, 434F and movable on a basis of one of or both of the vibration of the superconducting motor 2 and the external vibration, and the accordion cylinder portion 121, 121F arranged in the second insulation chamber portion (intermediate vacuum heat insulation chamber) 41c at an inner peripheral side of the second cover portion (intermediate container) 434E, 434F and including the accordion portion 120 that is connected to the movable body 106, 106F and that is deformable by extension and contraction based on a movement of the movable body 106, 106F.

Because the accordion portion 120 of the accordion cylinder portion 121 is repeatedly deformed by expansion and contraction based on the movement of the movable body 106, 106F, the vibrational energy is consumed to attenuate the vibration.

According to the aforementioned seventh embodiment, the vibration damping element 100H includes the first damping element 151 elastically supporting the superconducting motor 2 and the second damping element 152 elastically supporting the extremely low temperature generating portion 3.

At this time, the vibration applied to the superconducting motor 2 is attenuated by the first damping element 151. The vibration applied to the extremely low temperature generating portion 3 is attenuated by the second damping element 152. The first damping element 151 and the second damping element 152 desirably perform damping individually and independently.

According to the aforementioned embodiments, the conductive portion 33 is constituted by a member that includes one of a wire rod, a fibrous material, and a granular material, all of which are thermally conductive, as a base material, the member having a vibration absorption, and the conductive portion 33 is arranged between the extremely low temperature generating portion 3 and the superconducting motor 2.

The thermally conductive material includes aluminum, aluminum alloy, copper, copper alloy, or the like. The member including the wire rod, the fibrous material, and the granular material has a function for attenuating the vibration propagation as compared to a rigid body while achieving a temperature transfer between the extremely low temperature generating portion 3 and the superconducting motor 2.

According to the aforementioned fifth and sixth embodiments, the vibration damping element 100E, 100F includes the movable body 106, 106F arranged within the second insulation chamber portion (intermediate vacuum heat insulation chamber) 41c of the second cover portion (intermediate container) 434E, 434F and movable on a basis of the vibration from the superconducting motor 2, and the accordion cylinder portion 121 arranged in the second insulation chamber portion (intermediate vacuum heat insulation chamber) 41c at an inner peripheral side of the second cover portion (intermediate container) 434E, 434F and including the accordion portion 120 that is connected to the movable body 106, 106F and that is deformable by extension and contraction based on a movement of the movable body 106, 106F.

According to the aforementioned seventh embodiment, the vibration damping element 100H includes the first damping element 151 elastically supporting the superconducting motor 2 on the frame 300 and the second damping element 152 elastically supporting the extremely low temperature generating portion 3 on the frame 300.

The frame 300 is a body of a vehicle.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A superconducting motor apparatus comprising:
a superconducting motor including a superconducting coil and a mover movable on a basis of a movable magnetic field generated by the superconducting coil when an electric power is supplied thereto;
a container defining an outer vacuum heat insulation chamber that covers an outer side of the superconducting motor;
an extremely low temperature generating portion cooling the superconducting coil of the superconducting motor to a temperature equal to or smaller than a critical temperature of the superconducting coil; and
a vibration damping element restraining one of or both of a vibration of the superconducting motor and an external vibration from being propagated to the extremely low temperature generating portion.

2. The superconducting motor apparatus according to claim 1, wherein the vibration damping element includes a cylindrical body arranged between the container and the extremely low temperature generating portion and including a hollow chamber, a movable body movably arranged in the hollow chamber to divide the hollow chamber into a plurality of fluid chambers, and a connection passage connecting the plurality of fluid chambers to one another for attenuating the vibration by a movement of a fluid among the plurality of fluid chambers in association with a movement of the movable body.

3. The superconducting motor apparatus according to claim 1, wherein the container includes an outer container defining the outer vacuum heat insulation chamber that covers the outer side of the superconducting motor and an intermediate container defining an intermediate vacuum heat insulation chamber that covers a cold head of the extremely low temperature generating portion and arranged between the outer container and the extremely low temperature generating portion and wherein the vibration damping element is arranged within the intermediate vacuum heat insulation chamber of the intermediate container.

4. The superconducting motor apparatus according to claim 3, wherein the vibration damping element includes a movable body arranged within the intermediate vacuum heat insulation chamber of the intermediate container and movable on a basis of one of or both of the vibration of the superconducting motor and the external vibration, and an accordion cylinder portion arranged in the intermediate vacuum heat insulation chamber at an inner peripheral side of the intermediate container and including an accordion portion that is connected to the movable body and that is deformable by extension and contraction based on a movement of the movable body.

5. The superconducting motor apparatus according to claim 1, wherein the vibration damping element includes a first damping element elastically supporting the superconducting motor and a second damping element elastically supporting the extremely low temperature generating portion.

6. The superconducting motor apparatus according to claim 1, wherein the vibration damping element is constituted by a member that includes one of a wire rod, a fibrous material, and a granular material, all of which are thermally conductive, as a base material, the member having a vibration absorption, and the vibration damping element is arranged between the extremely low temperature generating portion and the superconducting motor.

7. A superconducting motor apparatus comprising:
a superconducting motor including a superconducting coil and a mover movable on a basis of a movable magnetic field generated by the superconducting coil when an electric power is supplied thereto;
a container defining an outer vacuum heat insulation chamber that covers an outer side of the superconducting motor;
an extremely low temperature generating portion arranged to be adjoined to the superconducting motor and cooling the superconducting coil of the superconducting motor to a temperature equal to or smaller than a critical temperature of the superconducting coil; and
a vibration damping element restraining a vibration from being propagated from the superconducting motor to the extremely low temperature generating portion.

8. The superconducting motor apparatus according to claim 7, wherein the vibration damping element includes a cylindrical body arranged between the container and the extremely low temperature generating portion and including a hollow chamber, a movable body movably arranged in the hollow chamber to divide the hollow chamber into a plurality of fluid chambers, and a connection passage connecting the plurality of fluid chambers to one another for attenuating the vibration by a movement of a fluid among the plurality of fluid chambers in association with a movement of the movable body.

9. The superconducting motor apparatus according to claim 7, wherein the container includes an outer container defining the outer vacuum heat insulation chamber that covers the outer side of the superconducting motor and an intermediate container defining an intermediate vacuum heat insulation chamber that covers a cold head of the extremely low temperature generating portion and arranged between the outer container and the extremely low temperature generating portion and wherein the vibration damping element is arranged within the intermediate vacuum heat insulation chamber of the intermediate container.

10. The superconducting motor apparatus according to claim 9, wherein the vibration damping element includes a movable body arranged within the intermediate vacuum heat insulation chamber of the intermediate container and movable on a basis of the vibration from the superconducting motor, and an accordion cylinder portion arranged in the intermediate vacuum heat insulation chamber at an inner peripheral side of the intermediate container and including an accordion portion that is connected to the movable body and that is deformable by extension and contraction based on a movement of the movable body.

11. The superconducting motor apparatus according to claim 7, wherein the vibration damping element includes a first damping element elastically supporting the superconducting motor on a frame and a second damping element elastically supporting the extremely low temperature generating portion on the frame.

12. The superconducting motor apparatus according to claim 11, wherein the frame is a body of a vehicle.

13. The superconducting motor apparatus according to claim 7, wherein the vibration damping element is constituted by a member that includes one of a wire rod, a fibrous material, and a granular material, all of which are thermally conductive, as a base material, the member having a vibration absorption, and the vibration damping element is arranged between the extremely low temperature generating portion and the superconducting motor.
